(19) United States
(12) Patent Application Publication
(10) Pub. No.: US 2013/0300864 A1
(43) Pub. Date: Nov. 14, 2013

(54) VIDEO MONITORING SYSTEM, IP CAMERA AND NETWORK CONNECTION SETUP METHOD THEREOF

(71) Applicant: SONIX TECHNOLOGY CO., LTD., Hsinchu (TW)

(72) Inventor: Chung-Chih Ko, Hsinchu County (TW)

(73) Assignee: SONIX TECHNOLOGY CO., LTD., Hsinchu (TW)

(21) Appl. No.: 13/661,016

(22) Filed: Oct. 25, 2012

(30) Foreign Application Priority Data
May 14, 2012 (TW) 101117077
May 14, 2012 (TW) 101117078

(51) Int. Cl. H04N 7/18; H04N 5/225

(52) U.S. Cl. 348/143; 348/207.1; 348/E07.085; 348/E05.024

(57) ABSTRACT

A video monitoring system, an IP camera and a network connection setup method are provided. The video monitoring system includes a video receiving device and a video transmitting device, and the network connection setup method is adapted to set a network connection configuration between the video transmitting device and a wireless AP or a wired router. The video receiving device displays guide information to guide a user to perform a wireless or wired network initialization setup to the video transmitting device. Then, the video receiving device provides an input interface to the user to input an operation message according to the guide information. Then, the video transmitting device completes the wireless or wired network initialization setup according to the received operation message. The IP camera has both functions of the video receiving device and the video transmitting device.

### CROSS-REFERENCE TO RELATED APPLICATION

This application claims the priority benefits of Taiwan application serial no. 101117078, filed on May 14, 2012, and Taiwan application serial no. 101117077, filed on May 14, 2012. The entirety of each of the above-mentioned patent applications is hereby incorporated by reference herein and made a part of specification.

### BACKGROUND

1. Technical Field

The invention relates to a video monitoring system, an IP camera and a network connection setup method thereof. Particularly, the invention relates to a video monitoring system where a user is capable of using a friendly interactive interface to easily implement a network connection configuration, an IP camera and a network connection setup method thereof.

2. Related Art

A general video monitoring system includes a camera device and a remote monitoring device, for example, regarding a baby monitoring system, by connecting the remote monitoring device to the camera device that captures images of a baby, the parents can monitor the baby's status at any time. However, the remote monitoring device is limited to be connected to the camera device through a near field wireless communication method, and if the parents want to monitor from a remote distance by using the aforementioned camera device, the Internet has to be additionally connected. Regarding the present technique, only a personal computer can be used to perform wireless network connection parameter setup to the camera device to implement network initialization setup of the camera device, for example, searching a base station of a wireless network, setting a password of the base station, setting an Internet protocol (IP) address, and setting a base station network packet forwarding address, etc., and after the setup is completed, the camera device is connected to the Internet. However, such setup flow is inconvenient to users not familiar with PC operations.

Moreover, regarding a conventional IP camera, a wired network interface (RJ-45) is required to connect a PC to input parameters for wireless network connection, so that a size and cost of the conventional IP camera cannot be reduced.

### SUMMARY

The invention is directed to a video monitoring system, an Internet protocol (IP) camera and a network connection setup method thereof, by which a friendly user interface is used to easily implement network connection configuration of the video monitoring system and the IP camera in an interactive teaching method.

The invention provides a video monitoring system including a video transmitting device and a video receiving device. The video transmitting device has a camera module, a first wireless near field communication interface, and a wireless network communication module supporting a first wireless communication protocol. The video receiving device connects the first wireless near field communication interface of the video transmitting device through a second wireless near field communication interface. The video receiving device includes a display unit, an input interface and a control unit. The display unit displays guide information for guiding a user to perform a wireless network initialization setup to the video transmitting device. The input interface is provided to the user to input an operation message according to the guide information. The control unit is coupled to the display unit and the input interface, which controls the display unit to display the guide information, and controls the video transmitting device to implement the wireless network initialization setup according to the received operation message. Then, the control unit controls the wireless network communication module to connect a second wireless network communication interface of a wireless access point (wireless AP) through a first wireless network communication interface supporting the first wireless communication protocol according to the wireless network initialization setup. The second wireless network communication interface also supports the first wireless communication protocol.

In an embodiment of the invention, the first wireless communication protocol compiles with a wireless fidelity (WiFi) standard, the wireless network communication module is a chipset supporting the WiFi standard, and the first wireless network communication interface and the second wireless network communication interface are an antenna set supporting the WiFi standard.

In an embodiment of the invention, the first wireless near field communication interface and the second wireless near field communication interface are an antenna set supporting a second wireless communication protocol, where the second wireless communication protocol includes a bluetooth standard, a wireless keyboard and mouse standard or other near field communication standards designed according to a digital radio frequency (RF) modulation technique.

In an embodiment of the invention, the wireless network initialization setup includes searching the wireless AP within a sensing range complied with the first wireless communication protocol, setting a password corresponding to the wireless AP, setting an internal network address of the video transmitting device corresponding to the wireless AP, and setting an external network forwarding address of the video transmitting device corresponding to the wireless AP.

In an embodiment of the invention, the input interface includes physical keys or a touch interface corresponding to the display unit.

The invention provides a network connection setup method, which is adapted to set a network connection configuration between a video transmitting device and a wireless access point (AP) through a video receiving device in a video monitoring system, where the wireless AP supports a first wireless communication protocol, and the video transmitting device has a wireless network communication module supporting the first wireless communication protocol, and the method includes following steps. A wireless near field communication interface is used to connect the video receiving device and the video transmitting device. Guide information is displayed on the video receiving device to guide a user to perform a wireless network initialization setup to the video transmitting device. An input interface is provided to the user through the video receiving device, so as to input an operation message according to the guide information to complete the wireless network initialization setup. The wireless network communication module connects the wireless AP through a wireless network communication interface supporting the first wireless communication protocol according to the wireless network initialization setup.

The invention provides a video monitoring system including a video transmitting device and a video receiving device. The video transmitting device has a camera module, a first wireless near field communication interface, and a wired network communication module supporting a wired communication protocol. The video receiving device connects the first wireless near field communication interface of the video transmitting device through a second wireless near field communication interface. The video receiving device includes a display unit, an input interface and a control unit. The display unit displays guide information for guiding a user to perform a wired network initialization setup to the video transmitting device. The input interface is provided to the user to input an operation message according to the guide information. The control unit is coupled to the display unit and the input interface, which controls the display unit to display the guide information, and controls the video transmitting device to implement the wired network initialization setup according to the received operation message. Then, the control unit controls the wired network communication module to connect a wired router through a wired network communication interface supporting the wired communication protocol according to the wired network initialization setup. The wired router also supports the wired communication protocol.

In an embodiment of the invention, the wired communication protocol complies with an Ethernet standard, the wired network communication module is a chipset supporting the Ethernet standard, and the wired network communication interface is a network cable supporting the Ethernet standard.

In an embodiment of the invention, the first wireless near field communication interface and the second wireless near field communication interface are an antenna set supporting a wireless communication protocol, where the wireless communication protocol includes a bluetooth standard, a wireless keyboard and mouse standard or other near field communication standards designed according to a digital RF modulation technique.

In an embodiment of the invention, the wired network initialization setup includes setting a password corresponding to the wired router, setting an internal network address of the video transmitting device corresponding to the wired router, and setting an external network forwarding address of the video transmitting device corresponding to the wired router.

In an embodiment of the invention, the input interface includes physical keys or a touch interface corresponding to the display unit.

The invention provides a network connection setup method, which is adapted to set a network connection configuration between a video transmitting device and a wired router through a video receiving device in a video monitoring system, where the wired router supports a wired communication protocol, and the video transmitting device has a wired network communication module supporting the wired communication protocol, and the method includes following steps. First, a wireless near field communication interface is used to connect the video receiving device and the video transmitting device. Guide information is displayed on the video receiving device to guide a user to perform a wired network initialization setup to the video transmitting device. An input interface is provided to the user through the video receiving device, so as to input an operation message according to the guide information to complete the wired network initialization setup. The wired network communication module connects the wired router through a wired network communication interface supporting the wired communication protocol according to the wired network initialization setup.

The invention provides an Internet protocol (IP) camera including a camera module, a wireless network communication module, a display unit, an input interface and a control unit. The wireless network communication module supports a wireless communication protocol. The display unit displays guide information for guiding a user to perform a wireless network initialization setup to the IP camera. The input interface is provided to the user to input an operation message according to the guide information. The control unit is coupled to the camera module, the wireless network communication module, the display unit and the input interface, which controls the display unit to display the guide information, and controls the IP camera to implement the wireless network initialization setup according to the received operation message. Then, the control unit controls the wireless network communication module to connect a second wireless network communication interface of a wireless access point (wireless AP) through a first wireless network communication interface supporting the wireless communication protocol according to the wireless network initialization setup, where the second wireless network communication interface also supports the wireless communication protocol.

The invention provides an Internet protocol (IP) camera including a camera module, a wired network communication module, a display unit, an input interface and a control unit. The wired network communication module supports a wired communication protocol. The display unit displays guide information for guiding a user to perform a wired network initialization setup to the IP camera. The input interface is provided to the user to input an operation message according to the guide information. The control unit is coupled to the camera module, the wired network communication module, the display unit and the input interface, which controls the display unit to display the guide information, and controls the IP camera to implement the wired network initialization setup according to the received operation message. Then, the control unit controls the wired network communication module to connect a wired router through a wired network communication interface according to the wired network initialization setup, where the wired network communication interface and the wired router all support the wired communication protocol.

According to the above descriptions, the invention provides the video monitoring system, the IP camera and the network connection setup method, in which initialization setup of the video transmitting device in the video monitoring system or initialization setup of the Internet protocol layer of the IP camera is implemented through a friendly and interactive teaching manner. Regarding the video monitoring system, the display unit of the video receiving device in the video monitoring system is used to display the guide information to facilitate the user inputting the related operation message through the input interface of the video receiving device according to the guide information, so as to implement a whole flow of the wired or wireless network initialization setup, where the above flow can be implemented without using a personal computer. In this way, the users unfamiliar with computer operations may easily operate the network connection setup method of the video transmitting device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a video monitoring system according to a first embodiment of the invention.

FIG. 2 is a flowchart illustrating a network connection setup method according to the first embodiment of the invention.

FIG. 3 is a functional block diagram of a video monitoring system according to a second embodiment of the invention.

FIG. 4 is a flowchart illustrating a network connection setup method according to the second embodiment of the invention.

FIG. 5 is a functional block diagram of an IP camera according to a third embodiment of the invention.

FIG. 6 is a flowchart illustrating a network connection setup method according to the third embodiment of the invention.

FIG. 7 is a functional block diagram of an IP camera according to a fourth embodiment of the invention.

FIG. 8 is a flowchart illustrating a network connection setup method according to the fourth embodiment of the invention.

### DETAILED DESCRIPTION OF DISCLOSED EMBODIMENTS

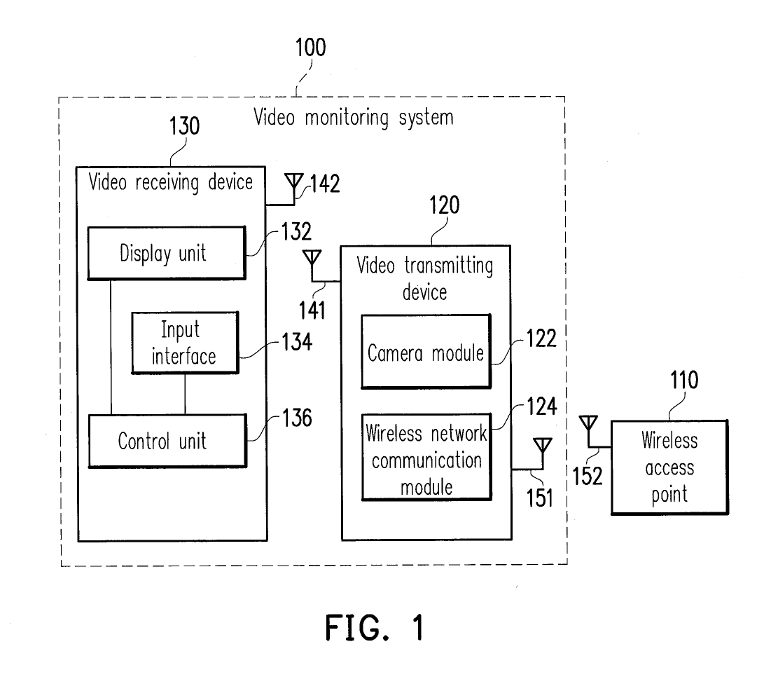

FIG. 1 is a functional block diagram of a video monitoring system according to a first embodiment of the invention, the video monitoring system 100 of FIG. 1 includes a video transmitting device 120 and a video receiving device 130, where the video transmitting device 120 has a camera module 122, a first wireless near field communication interface (which is and antenna 141 in the present embodiment), and a wireless network communication module 124 supporting a first wireless communication protocol. The first wireless communication protocol complies with a wireless fidelity (WiFi) standard, and the wireless network communication module 124 is a chipset supporting the WiFi standard. In the present embodiment, the video receiving device 130 connects the antenna 141 of the video transmitting device 120 through a second wireless near field communication interface (which is and antenna 142 in the present embodiment), and receives and monitors video streams transmitted from the video transmitting device 120. The antenna 141 and the antenna 142 are an antenna set supporting a second wireless communication protocol, where the second wireless communication protocol includes a bluetooth standard, a wireless keyboard and mouse standard or other near field communication standards designed according to a digital radio frequency (RF) modulation technique, for example, a 2.4G RF standard.

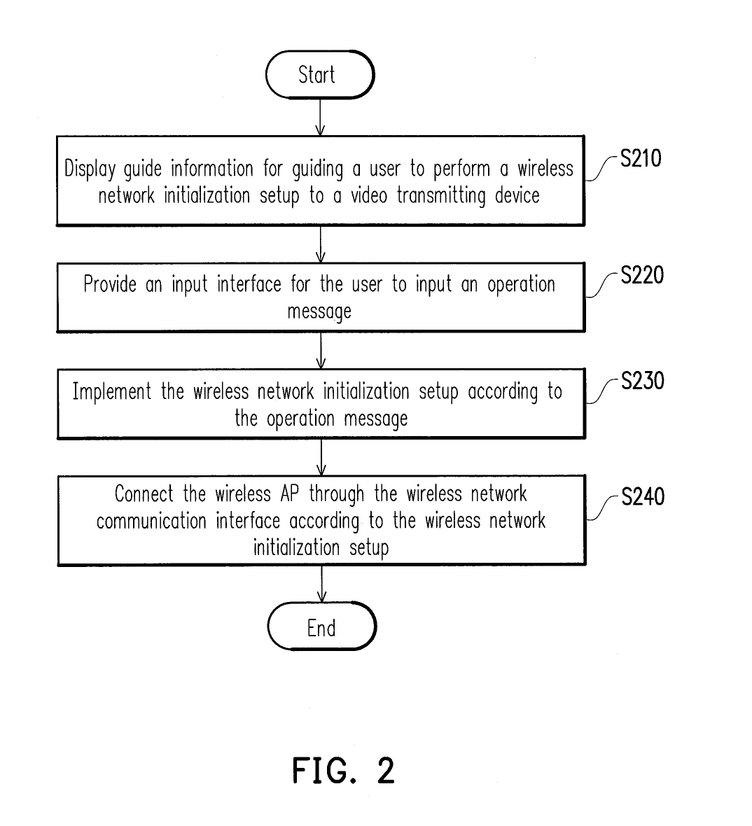

The video receiving device 130 includes a display unit 132, an input interface 134 and a control unit 136. The display unit 132 is, for example, a screen of the video receiving device 130, and displays video streams transmitted from the video transmitting device 120. The input interface 134 can be physical keys or a touch interface corresponding to the display unit 132, through which the user can operate the video receiving device 130 according to an actual demand. The control unit 136 is coupled to the display unit 132 and the input interface 134, which can be a functional block implemented by hardware and/or software, where the hardware includes hardware equipment having a computation function such as a central processor, a chipset, a microprocessor, or a combination thereof, and the software can be an operating system or a driving program, etc. In the present embodiment, the display unit 132 of the video receiving device 130 is used to display guide information for guiding a user to operate the input interface 134 to set a network connection configuration between the video transmitting device 120 and a wireless access point (AP) 110 supporting the first wireless communication protocol through an interactive and teaching manner, where an operation method thereof is described in detail below with reference of a flowchart of FIG. 2.

FIG. 2 is a flowchart illustrating a network connection setup method according to the first embodiment of the invention. Referring to FIG. 1 and FIG. 2, first, the control unit 136 in the video receiving device 130 controls the display unit 132 to display guide information for guiding a user to perform a wireless network initialization setup to the video transmitting device 120 (step S210). Then, the video receiving device 130 provides the input interface 134 for the user to input an operation message according to the guide information (step S220). Then, the control unit 136 of the video receiving device 130 controls the video transmitting device 120 to implement the wireless network initialization setup according to the received operation message (S230). Then, the wireless network communication module 124 connects a second wireless network communication interface (which is an antenna 152 in the present embodiment) of the wireless AP 110 through a first wireless network communication interface (which is an antenna 151 in the present embodiment) supporting the first wireless communication protocol according to the wireless network initialization setup (step 240). The antenna 151 and the antenna 152 also support the first wireless communication protocol, for example, the antenna 151 and the antenna 152 are an antenna set supporting the WiFi standard.

Regarding a presenting method of the guide information, it can be a menu or an input table displayed on the display unit 132, and the menu or the input table provides the user to simply select or input operation message through the input interface 134. Moreover, the wireless network initialization setup includes searching the wireless AP 110 within a sensing range complied with the first wireless communication protocol, setting a password corresponding to the wireless AP 110, setting an internal network address of the video transmitting device 120 corresponding to the wireless AP 110, setting an external network forwarding address of the video transmitting device 120 corresponding to the wireless AP 110.

For example, the display unit 132 first displays a menu for the user to select a network mode. The network mode includes a wireless AP mode and a personal network mode, and when none wireless AP is available around the user, the user can use the input interface 134 to select the personal network mode, and the wireless network communication module 124 of the video emitting device 120 can be simulated for a wireless access point, and now the display unit 132 displays a service set identifier (SSID) and a password corresponding to the video transmitting device 120. After the user inputs the correct SSID and password to successfully establish the connection, the display unit 132 displays an internal network address corresponding to the video transmitting device 120. Thereafter, the user can input the internal network address in other electronic device (e.g. Smart phone or Tablet), and view image streams captured by the video transmitting device 120 through the electronic device. Since the wireless network communication module 124 simulates for a wireless access point, the display device (e.g. Smart phone or Tablet) which has the WiFi ability can connect to the video emitting device 120 directly. Therefore, the personal network mode solves the problem that there are no access points in user environment.

If the user selects the wireless AP mode, the control unit 136 controls the video transmitting device 120 to search available wireless APs within the sensing range complied with the first wireless communication protocol, and the applicable wireless APs within the sensing range are displayed on the display unit 132 in names of SSIDs. Then, after the user selects a wireless AP (for example, the wireless AP 110) through the input interface 134, and inputs a corresponding password to successfully establish the connection, the display unit 132 displays the internal network address and the external network forwarding address corresponding to the wireless AP 110. Now, if the user is within the sensing range of the wireless AP 110, the user can input the internal network address in an electronic device, and after the wireless AP 110 is successfully connected, the user can monitor the image streams captured by the video transmitting device 120. Moreover, when the user is in other regions other than the sensing range of the wireless AP 110, the user can input the external network forwarding address in the electronic device, and monitor the image streams captured by the video transmitting device 120 through an external network.

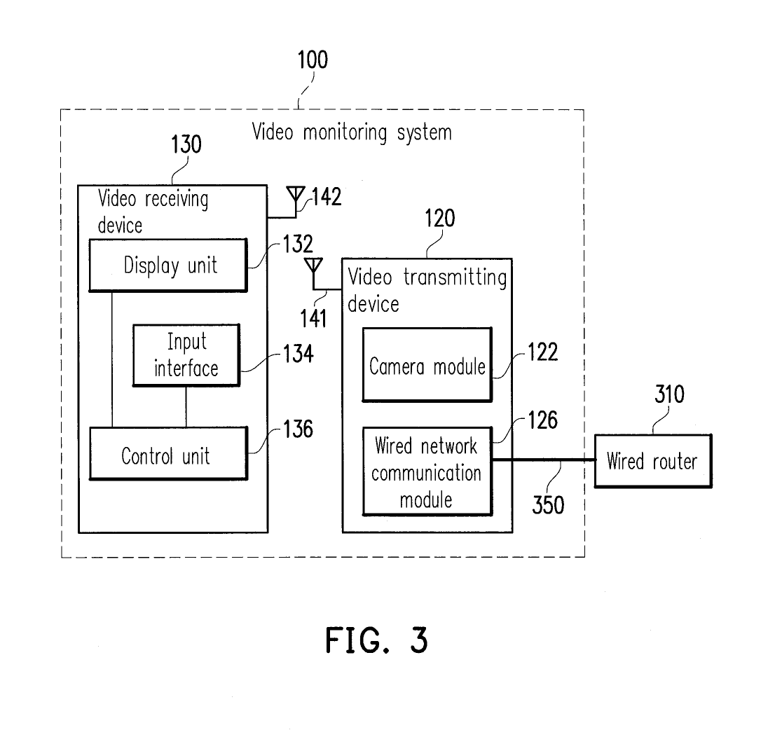

FIG. 3 is a functional block diagram of a video monitoring system according to a second embodiment of the invention. The second embodiment is a variation of the first embodiment, where the same parts are not repeated and only differences there between are described below. A main variation of the second embodiment is that the video transmitting device 120 further includes a wired network communication module 126, where the wired network communication module 126 is connected to a wired router 310 through a wired network communication interface 350, where the wired network communication interface 350 and the wired router 310 support a wired network protocol, and the wired network protocol complies with an Ethernet standard. For example, the wired network communication module 126 is a chipset supporting the Ethernet standard, and the wired network communication interface 350 is a network cable supporting the Ethernet standard.

It should be noticed that the wired network communication module 126 of the second embodiment can be used to replace the wireless network communication module 124 of FIG. 1, such that the whole video monitoring system 100 is connected to the Internet through a wired manner, or the wired network communication module 126 can be used together with the wireless network communication module 124. Namely, the user can freely select to connect the Internet through the wired manner or a wireless manner according to an actual network environment.

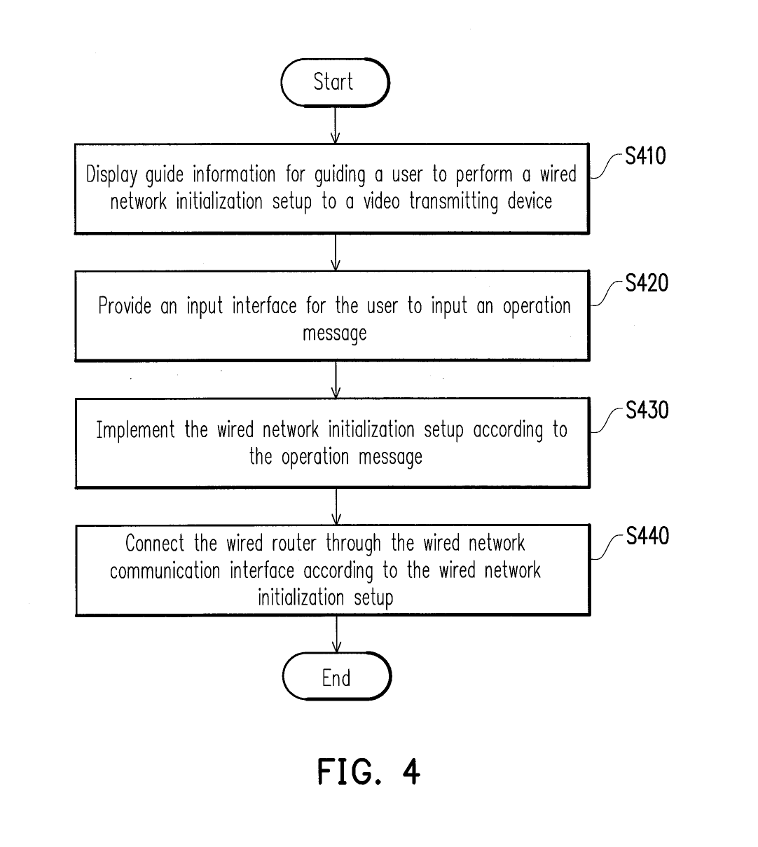

FIG. 4 is a flowchart illustrating a network connection setup method according to the second embodiment of the invention. Referring to FIG. 3 and FIG. 4, first, the control unit 136 in the video receiving device 130 controls the display unit 132 to display guide information for guiding a user to perform a wired network initialization setup to the video transmitting device 120 (step S410). Then, the video receiving device 130 provides the input interface 134 for the user to input an operation message according to the guide information (step S420). Then, the control unit 136 of the video receiving device 130 controls the video transmitting device 120 to implement the wired network initialization setup according to the received operation message (S430). Then, the wired network communication module 126 connects the wired router 310 through the wired network communication interface 350 supporting the wired communication protocol according to the wired network initialization setup (step 440).

Compared to the wireless network initialization setup, the wired network initialization setup is pure. In the present embodiment, the wired network initialization setup includes setting a password corresponding to the wired router 310, setting an internal network address of the video transmitting device 120 corresponding to the wired router 310, setting an external network forwarding address of the video transmitting device 120 corresponding to the wired router 310. After the setup is completed, when the user connects an electronic device to the wired router 310 through a wired manner, the user can input the internal network address in the electronic device, and after the connection is successfully established, the user can monitor the image streams captured by the video transmitting device 120. Moreover, when the user is in other regions, the user can input the external network forwarding address in the electronic device, and monitor the image streams captured by the video transmitting device 120 through an external network.

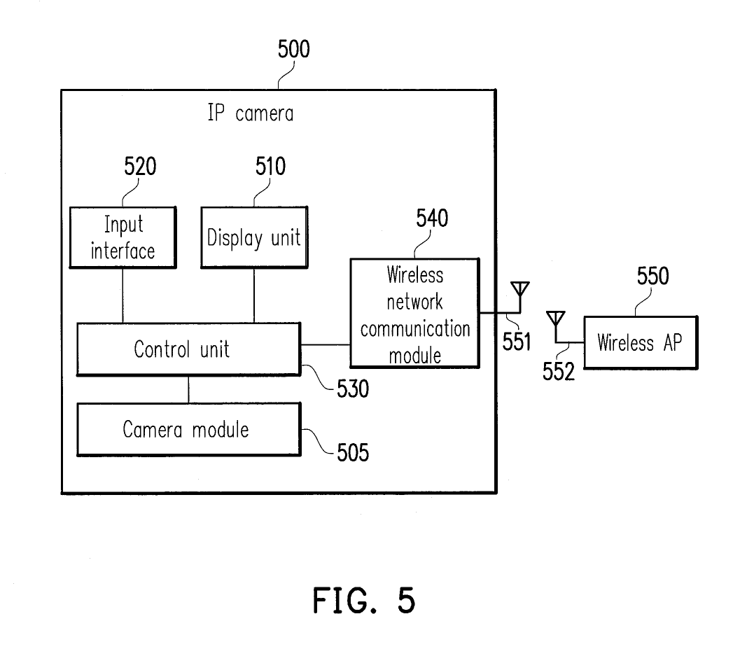

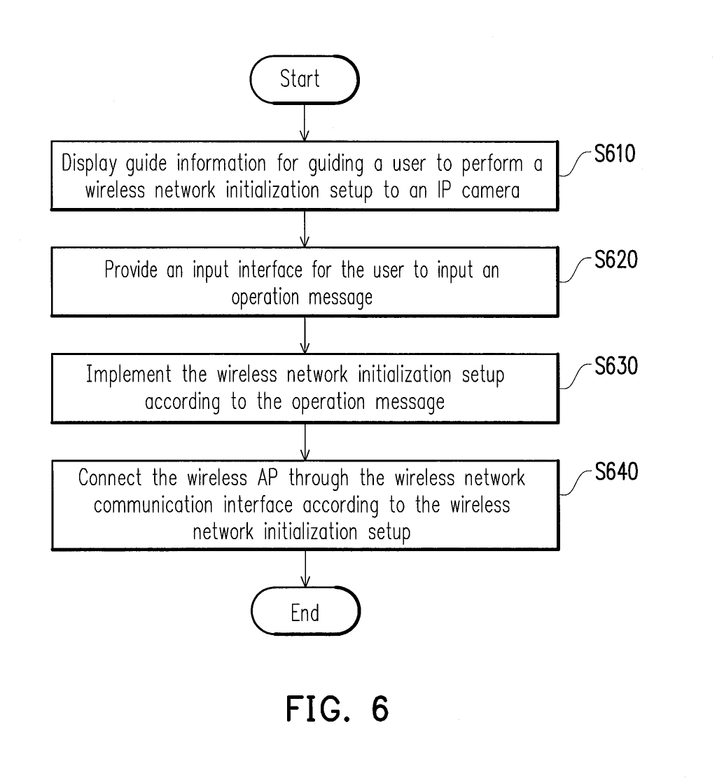

FIG. 5 is a functional block diagram of an IP camera according to a third embodiment of the invention. The IP camera 500 of FIG. 5 includes a camera module 505, a display unit 510, an input interface 520, a control unit 530 and a wireless network communication module 540. The wireless network communication module 540 supports a wireless communication protocol, where the wireless communication protocol complies with a wireless fidelity (WiFi) standard, and the wireless network communication module 540 is a chipset supporting the WiFi standard. The display unit 520 can be a screen of the IP camera 500, and is capable of displaying the image steams captured by the camera module 505. The input interface 520 can be physical keys or a touch interface corresponding to the display unit 510, through which the user can operate the IP camera 500 according to an actual demand. The control unit 530 is coupled to the camera module 505, the display unit 510, the input interface 520 and the wireless network communication module 540, which can be a functional block implemented by hardware and/or software, where the hardware includes hardware equipment having a computation function such as a central processor, a chipset, a microprocessor, or a combination thereof, and the software can be an operating system or a driving program, etc. In the present embodiment, the display unit 510 is used to display guide information for guiding a user to operate the input interface 520 to set a network connection configuration between the IP camera 500 and a wireless AP 550 supporting the wireless communication protocol through an interactive and teaching manner, where an operation method thereof is described in detail below with reference of a flowchart of FIG. 6.

FIG. 6 is a flowchart illustrating a network connection setup method according to the third embodiment of the invention. Referring to FIG. 5 and FIG. 6, first, the control unit 530 in the IP camera 500 controls the display unit 510 to display guide information for guiding a user to perform a wireless network initialization setup to the IP camera 500 (step S610). Then, the IP camera 500 provides the input interface 520 for the user to input an operation message according to the guide information (step S620). Then, the control unit 530 controls the IP camera 500 to implement the wireless network initialization setup according to the received operation message (S630). Then, the wireless network communication module 540 connects a second wireless network communication interface (which is an antenna 552 in the present embodiment) of the wireless AP 550 through a first wireless network communication interface (which is an antenna 551 in the present embodiment) supporting the wireless communication protocol according to the wireless network initialization setup (step 640). The antenna 551 and the antenna 552 also support the wireless communication protocol, for example, the antenna 551 and the antenna 552 are an antenna set supporting the WiFi standard.

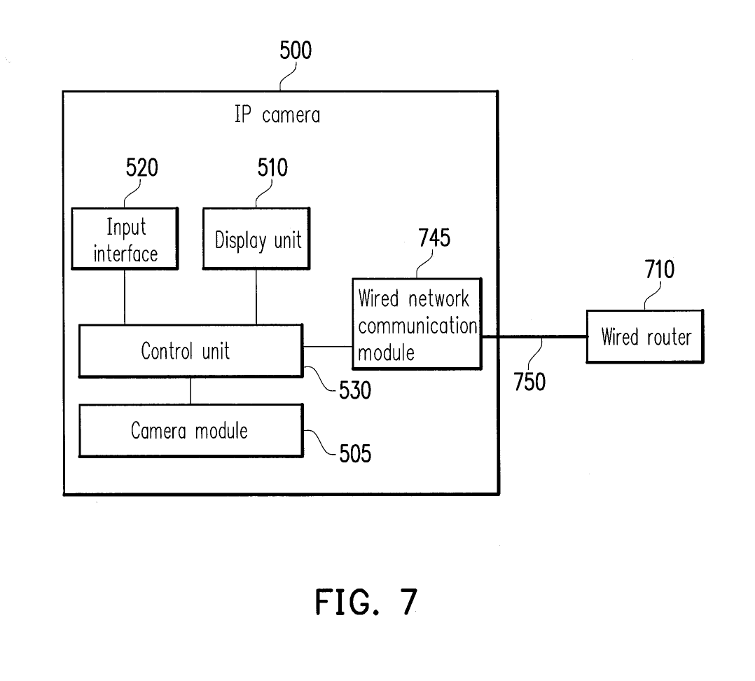

FIG. 7 is a functional block diagram of an IP camera according to a fourth embodiment of the invention. The fourth embodiment is a variation of the third embodiment, where the same parts are not repeated and only differences there between are described below. A main variation of the fourth embodiment is that the IP camera 500 further includes a wired network communication module 745, where the wired network communication module 745 is connected to a wired router 710 through a wired network communication interface 750, where the wired network communication interface 750 and the wired router 710 support a wired network protocol, and the wired network protocol complies with an Ethernet standard. For example, the wired network communication module 745 is a chipset supporting the Ethernet standard, and the wired network communication interface 750 is a network cable supporting the Ethernet standard.

It should be noticed that the wired network communication module 745 of the fourth embodiment can be used to replace the wireless network communication module 540 of FIG. 5, such that the IP camera 500 is connected to the Internet through a wired manner, or the wired network communication module 745 can be used together with the wireless network communication module 540. Namely, the user can freely select to connect the Internet through the wired manner or a wireless manner according to an actual network environment.

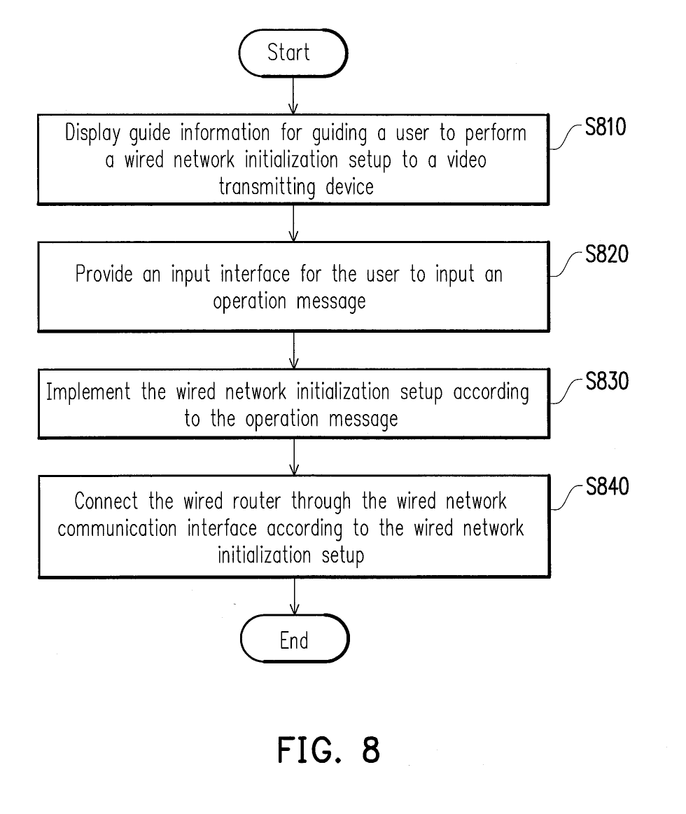

FIG. 8 is a flowchart illustrating a network connection setup method according to the fourth embodiment of the invention. Referring to FIG. 7 and FIG. 8, first, the control unit 530 in the IP camera 500 controls the display unit 510 to display guide information for guiding a user to perform a wired network initialization setup to the IP camera 500 (step S810). Then, the IP camera 500 provides the input interface 520 for the user to input an operation message according to the guide information (step S820). Then, the control unit 530 of the IP camera 500 controls the IP camera 500 to implement the wired network initialization setup according to the received operation message (S830). Then, the wired network communication module 745 connects the wired router 710 through the wired network communication interface 750 supporting the wired communication protocol according to the wired network initialization setup (step 840).

In summary, the invention provides the video monitoring system, the IP camera and the network connection setup method, in which initialization setup of the video transmitting device in the video monitoring system or initialization setup of the Internet protocol layer of the IP camera is implemented through a friendly and interactive teaching manner. Regarding the video monitoring system, the display unit of the video receiving device in the video monitoring system is used to display the guide information to facilitate the user inputting the related operation message through the input interface of the video receiving device according to the guide information, so as to implement a whole flow of the wired or wireless network initialization setup, where the above flow can be implemented without using a personal computer. In this way, the users unfamiliar with computer operations may easily operate the network connection setup method of the video transmitting device. Moreover, after the network initialization setup is implemented through the aforementioned interactive method, the display unit on the video receiving device can further display an Internet login address (the internal network address or the external network forwarding address) of the video transmitting device, and the user can input the Internet login address in other electronic device, so as to connect the video transmitting device through the remote electronic device, and view and hear images and sounds captured by the video transmitting device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A video monitoring system, comprising:
a video transmitting device, having a camera module, a first wireless near field communication interface and a wireless network communication module supporting a first wireless communication protocol; and
a video receiving device, connecting the first wireless near field communication interface of the video transmitting device through a second wireless near field communication interface, and comprising:
a display unit, displaying guide information for guiding a user to perform a wireless network initialization setup to the video transmitting device;
an input interface, provided to the user to input an operation message according to the guide information; and
a control unit, coupled to the display unit and the input interface, controlling the display unit to display the guide information, controlling the video transmitting device to implement the wireless network initialization setup according to the received operation message, and controlling the wireless network communication module to connect a second wireless network communication interface of a wireless access point (AP) through a first wireless network communication interface supporting the first wireless communication protocol according to the wireless network initialization setup, wherein the second wireless network communication interface also supports the first wireless communication protocol.

2. The video monitoring system as claimed in claim 1, wherein the first wireless communication protocol compiles with a wireless fidelity (WiFi) standard, the wireless network communication module is a chipset supporting the WiFi standard, and the first wireless network communication interface and the second wireless network communication interface are an antenna set supporting the WiFi standard.

3. The video monitoring system as claimed in claim 1, wherein the first wireless near field communication interface and the second wireless near field communication interface are an antenna set supporting a second wireless communication protocol, wherein the second wireless communication protocol comprises a bluetooth standard, a wireless keyboard and mouse standard or other near field communication standards designed according to a digital radio frequency modulation technique.

4. The video monitoring system as claimed in claim 1, wherein the wireless network initialization setup comprises searching the wireless AP within a sensing range complied with the first wireless communication protocol, setting a password corresponding to the wireless AP, setting an internal network address of the video transmitting device corresponding to the wireless AP, and setting an external network forwarding address of the video transmitting device corresponding to the wireless AP.

5. The video monitoring system as claimed in claim 1, wherein the input interface comprises physical keys or a touch interface corresponding to the display unit.

6. A network connection setup method, adapted to set a network connection configuration between a video transmitting device and a wireless access point (AP) through a video receiving device in a video monitoring system, wherein the wireless AP supports a first wireless communication protocol, and the video transmitting device has a wireless network communication module supporting the first wireless communication protocol, and the network connection setup method comprising:
using a wireless near field communication interface to connect the video receiving device and the video transmitting device;
displaying guide information on the video receiving device to guide a user to perform a wireless network initialization setup to the video transmitting device;
providing an input interface to the user through the video receiving device, so as to input an operation message according to the guide information to complete the wireless network initialization setup; and
connecting the wireless network communication module to the wireless AP through a wireless network communication interface supporting the first wireless communication protocol according to the wireless network initialization setup.

7. The network connection setup method as claimed in claim 6, wherein the first wireless communication protocol compiles with a wireless fidelity (WiFi) standard, the wireless network communication module is a chipset supporting the WiFi standard, and the wireless network communication interface is an antenna set supporting the WiFi standard.

8. The network connection setup method as claimed in claim 6, wherein the first wireless near field communication interface and the second wireless near field communication interface are an antenna set supporting a second wireless communication protocol, wherein the second wireless communication protocol comprises a bluetooth standard, a wireless keyboard and mouse standard or other near field communication standards designed according to a digital radio frequency modulation technique.

9. The network connection setup method as claimed in claim 6, wherein the wireless network initialization setup comprises searching the wireless AP within a sensing range complied with the first wireless communication protocol, setting a password corresponding to the wireless AP, setting an internal network address of the video transmitting device corresponding to the wireless AP, and setting an external network forwarding address of the video transmitting device corresponding to the wireless AP.

10. A video monitoring system, comprising:
a video transmitting device, having a camera module, a first wireless near field communication interface and a wired network communication module supporting a wired communication protocol; and
a video receiving device, connecting the first wireless near field communication interface of the video transmitting device through a second wireless near field communication interface, and comprising:
a display unit, displaying guide information for guiding a user to perform a wired network initialization setup to the video transmitting device;
an input interface, provided to the user to input an operation message according to the guide information; and
a control unit, coupled to the display unit and the input interface, controlling the display unit to display the guide information, controlling the video transmitting device to implement the wired network initialization setup according to the received operation message, and controlling the wired network communication module to connect a wired router through a wired network communication interface supporting the wired communication protocol according to the wired network initialization setup, wherein the wired router supports the wired communication protocol.

11. The video monitoring system as claimed in claim 10, wherein the wired communication protocol complies with an Ethernet standard, the wired network communication module is a chipset supporting the Ethernet standard, and the wired network communication interface is a network cable supporting the Ethernet standard.

12. The video monitoring system as claimed in claim 10, wherein the first wireless near field communication interface and the second wireless near field communication interface are an antenna set supporting a wireless communication protocol, wherein the wireless communication protocol comprises a bluetooth standard, a wireless keyboard and mouse standard or other near field communication standards designed according to a digital radio frequency modulation technique.

13. The video monitoring system as claimed in claim 10, wherein the wired network initialization setup comprises setting a password corresponding to the wired router, setting an internal network address of the video transmitting device corresponding to the wired router, and setting an external network forwarding address of the video transmitting device corresponding to the wired router.

14. The video monitoring system as claimed in claim 10, wherein the input interface comprises physical keys or a touch interface corresponding to the display unit.

15. A network connection setup method, adapted to set a network connection configuration between a video transmitting device and a wired router through a video receiving device in a video monitoring system, wherein the wired router supports a wired communication protocol, and the video transmitting device has a wired network communication module supporting the wired communication protocol, and the network connection setup method comprising:
using a wireless near field communication interface to connect the video receiving device and the video transmitting device;
displaying guide information on the video receiving device to guide a user to perform a wired network initialization setup to the video transmitting device;
providing an input interface to the user through the video receiving device, so as to input an operation message according to the guide information to complete the wired network initialization setup; and
connecting the wired network communication module to the wired router through a wired network communication interface supporting the wired communication protocol according to the wired network initialization setup.

16. The network connection setup method as claimed in claim 15, wherein the wired communication protocol complies with an Ethernet standard, the wired network communication module is a chipset supporting the Ethernet standard, and the wired network communication interface is a network cable supporting the Ethernet standard.

17. The network connection setup method as claimed in claim 15, wherein the first wireless near field communication interface and the second wireless near field communication interface are an antenna set supporting a wireless communication protocol, wherein the wireless communication protocol comprises a bluetooth standard, a wireless keyboard and mouse standard or other near field communication standards designed according to a digital radio frequency modulation technique.

18. The network connection setup method as claimed in claim 15, wherein the wired network initialization setup comprises setting a password corresponding to the wired router, setting an internal network address of the video transmitting device corresponding to the wired router, and setting an external network forwarding address of the video transmitting device corresponding to the wired router.

19. An Internet protocol (IP) camera, comprising:
a camera module;
a wireless network communication module, supporting a wireless communication protocol;
a display unit, displaying guide information for guiding a user to perform a wireless network initialization setup to the IP camera;
an input interface, provided to the user to input an operation message according to the guide information; and
a control unit, coupled to the camera module, the wireless network communication module, the display unit and the input interface, controlling the display unit to display the guide information, controlling the IP camera to implement the wireless network initialization setup according to the received operation message, and controlling the wireless network communication module to connect a second wireless network communication interface of a wireless access point (wireless AP) through a first wireless network communication interface supporting the wireless communication protocol according to the wireless network initialization setup, wherein the second wireless network communication interface also supports the wireless communication protocol.

20. An Internet protocol (IP) camera, comprising:
a camera module;
a wired network communication module, supporting a wired communication protocol;
a display unit, displaying guide information for guiding a user to perform a wired network initialization setup to the IP camera;
an input interface, provided to the user to input an operation message according to the guide information; and
a control unit, coupled to the camera module, the wired network communication module, the display unit and the input interface, controlling the display unit to display the guide information, controlling the IP camera to implement the wired network initialization setup according to the received operation message, and controlling the wired network communication module to connect a wired router through a wired network communication interface according to the wired network initialization setup, wherein the wired network communication interface and the wired router all support the wired communication protocol.
